(19) United States
(12) Patent Application Publication
(10) Pub. No.: US 2022/0232389 A1
(43) Pub. Date: Jul. 21, 2022

(54) WI-FI SECURITY

(71) Applicant: WIFI SECURITIES LIMITED, Liverpool (GB)

(72) Inventors: Julian WATTS, Liverpool (GB); SHILLADAY Andrew, Liverpool (GB); Alex LENNON, Liverpool (GB)

(21) Appl. No.: 17/614,320

(22) PCT Filed: May 26, 2020
(86) PCT No.: PCT/GB2020/051266

§ 371 Date: Nov. 24, 2021

(30) Foreign Application Priority Data
May 24, 2019 (GB) 1907425.1

(51) Int. Cl. H04W 12/73; H04W 12/08; H04W 12/122

(52) U.S. Cl. CPC H04W 12/73; H04W 12/122; H04W 12/08

(57) ABSTRACT

A method and apparatus of securing a Wi-Fi network is disclosed, which uses a Wi-Fi Protection Device or “WPD” to: performing a network scan to detect all in-range Wi-Fi devices; identify any access points from among the list of all detected in-range Wi-Fi devices; identify any client devices from among the list of all detected in-range Wi-Fi devices; determine the access points to which each detected client device is connected; determine which access points are legitimate; and disconnect or prevent the connection between any clients that are connected to access points which have not been determined to be legitimate and the respective access point which has not been determined to be legitimate, preferably, by determining a similarity metric, which is an indication of a degree of similarity between the ESSID of an access point under consideration and the ESSID of one or more legitimate access points and by making that determination based on whether the similarity metric is above or below a specified threshold value. The WPD is station device, but is neither a client nor an AP device.

This invention relates to Wi-Fi security, and in particular, but without limitation, to a system and method for protecting users of Wi-Fi networks.

Many modern portable electronic devices (such as mobile telephones, laptop computers and tablet computers) have, or require, internet or data connections. Many such portable electronic devices connect to networks using Wi-Fi and as the demand for data increases, so does the ubiquity of Wi-Fi service providers.

Wi-Fi is a wireless networking system that enables client devices to connect to networks and/or the internet via an access point. Because Wi-Fi is a broadcast medium, where all data packets sent and received are potentially visible to all other in-range devices, Wi-Fi requires security measures to be implemented to control access between devices—be they bridges between wired and wireless networks, wireless access points and client devices. In order to secure a Wi-Fi network, the access point can be configured to require login authentication (for example via WPS or an SSID/password combination) so that only users in possession of the correct authentication keys can gain access to the Access Point and any networks beyond it. Firewalls and network switches are often incorporated into APs to provide security features, routing services, network segregation etc. All this is well known.

One drawback of secure Wi-Fi networks is that they require authentication between the AP and client, but the act of logging into a Wi-Fi network can be inconvenient. For example, where the password is long and/or complex, entering it correctly can be error-prone, and this places an undue burden on users where they only need to connect for a short period of time. Another known vulnerability of “secure” Wi-Fi networks is that oftentimes, the login credentials (SSID and password) are displayed on a sign or placard, or simply handed out to users. Once any one person has obtained the access credentials, there is little to stop that person sharing those credentials with other people. However, such lazy practices are ultimately the concern/fault of the Wi-Fi service provider and are not directly relevant to the present disclosure, which is concerned principally with “open” Wi-Fi networks.

In Wi-Fi environments, such as in coffee shops and hotel lobbies, where many transient users may wish to access a Wi-Fi service, it is therefore commonplace for some security features on the AP to be disabled, thereby rendering the AP “open”, that is to say, not requiring login authentication to connect to it. This is sometimes referred to as “open-access” Wi-Fi or “guest” Wi-Fi, and the only security measure in place is that a device wishing to connect to the Wi-Fi network must be in-range of another Wi-Fi enabled device on the Wi-Fi network.

Open Wi-Fi enables any in-range client or other device(s) to automatically connect to the Wi-Fi network, often without user intervention, i.e. without having to enter login credentials, such as an SSID and password. Typically, open Wi-Fi only automatically connects if the client device has previously connected to the exact open access ESSID. The client still must choose what open access to connect to, but without having to enter a password. The client connects to the Extended Service Set Identifier (ESSID) ‘the name’ of the access point which consists of all the individual Basic Service Set Identifiers (BSSID) Media Access Control (MAC) addresses in the network. The client device cannot determine the legitimacy of the BSSID associated to the ESSID. Open access renders the system more user-friendly, but potentially poses a security risk because any data exchanged between the AP and the devices connected to the AP (the “client” devices) is broadcast openly, and thus not secured.

Whilst it is unlikely that a legitimate provider of an open Wi-Fi service, such as a hotel proprietor, would wish to be involved in data theft or fraud, there exists a real risk that hackers might wish to exploit the vulnerabilities of end-users who have become accustomed to using open Wi-Fi services.

An example of such a situation is where a hacker places an access point in an area alongside a legitimate open access point. Users entering the premises of a reputable provider (such as a hotel or coffee shop chain) area would expect to connect to a legitimate access point in that area, but inadvertently connect to the hacker's access point. The hacker is then able to obtain data from the unsuspecting end-user's device, and then engage in malicious or fraudulent activity using that data.

In order to deceive the end-user into thinking that they are connecting to a legitimate open access point, hackers are known to configure their AP to broadcast a name (SSID) for their access point, which is the same as, or very similar to, the SSID of the legitimate access point. For example, the legitimate AP could have an SSID “Hotel-WiFi”. As the SSID of an AP is easily user-configurable, the malicious AP could be given the same SSID (“Hotel-WiFi”) as the legitimate AP; a similar SSID, such as “Hotel-Lobby”; or even something more alluring, such as “Superfast-Hotel-WiFi”. In all cases, the end user is unaware that they have connected to the malicious AP due to the similarity between the malicious AP's SSID and the SSID of the legitimate AP. In this example, the malicious access point is known colloquially as an “evil twin” access point.

Of all hacking types, the “evil twin” attack probably poses one of the highest security risks to end-users, who may be completely unaware of the existence of such risks, and in any event, may not be protected by data protection laws in certain jurisdictions as a result of having “willingly”, albeit unknowingly, connected to the “evil twin” AP.

A need therefore exists for a solution, or countermeasure, to “evil twin” attacks, which aspects of the present invention aim to provide.

According to one aspect of the invention, there is provided a method of securing a Wi-Fi network comprising the steps of: using a Wi-Fi Protection Device (WPD), performing a network scan to detect all in-range Wi-Fi devices; identifying any access points from among the list of all detected in-range Wi-Fi devices; identifying any client devices from among the list of all detected in-range Wi-Fi devices; determining the access points to which each detected client device is connected; determining which access points are legitimate; and disconnecting or preventing the connection between any clients that are connected to access points which have not been determined to be legitimate and the respective access point which has not been determined to be legitimate.

The method preferably involves the step of differentiating between open and secured APs. This could be accomplished, for example, by determining which of the detected APs requires a password or other security measure to connect to it; or by using the protocol definition to determine this through passive scanning of the network. Having determined which are the in-range open APs and which are the in-range secured APs, the method preferably disregards all secured APs and only makes a determination as to the legitimacy or otherwise of the open APs.

Additionally or alternatively, the method also preferably involves the step of differentiating between open (e.g. connected to open APs) and secured clients (e.g. connected to password-protected APs). This could be accomplished, for example, by determining which of the detected clients are using passwords or other security measure to connect to APs. Having determined which are the in-range open/unsecured clients and which are the in-range secured clients, the method preferably disregards all secured clients and only disconnects or prevents connection between any in-range open/unsecured clients and APs.

By either or both of these means, the WPD does not interfere with, or in any way actively interact with, any secured connections on any in-range Wi-Fi network(s). The justification for this is twofold: on the one hand, secured clients and/or APs already have safeguards in place to minimise or prevent malicious interference; and secondly, it avoids or reduces the likelihood of the WPD adversely affecting third-party Wi-Fi network(s) unrelated to the provider of the WPD.

In this disclosure, the device which carries out the method is a Wi-Fi Protection Device, or a “WPD”, which is neither a client nor an access point (AP). In other words, the WPD does not connect to the Wi-Fi network, but rather simply scans for data and/or broadcasts data using a Wi-Fi compatible protocol and/or frequency. That is not to say, however, that the WPD could not be incorporated into an AP, or have a physical (e.g. an RJ45 LAN) network connection, but that the WPD and client/AP functions are physically or logically separated.

The IEEE Standard for Information technology—Telecommunications and information exchange between systems—Local and metropolitan area networks—Specific requirements—Part 11: Wireless LAN Media Access Control (MAC) and Physical Layer (PHY) Specifications (The “IEEE 802.11” standard) defines at part 11, 3.3, an “Access point (AP)” as being:
“ . . . Any entity that has station (STA) functionality and provides access to the distribution services, via the wireless medium (WM) for associated STAs . . . ”;

Also, at part 11, 3.39 of IEEE 802.11, a “Distribution service” is defined as:
“ . . . The service that, by using association information, delivers media access control (MAC) service data units (MSDUs) within the distribution system (DS) . . . ”

On the other hand, the WPD of the invention does not deliver any information, or provide access to any information, so it doesn't provide a distribution service and so it is not an AP. Similarly, the WPD of the invention does not connect to any AP, or access data beyond any AP, so is not a client device either. Put simply, the WPD of the invention is merely a Wi-Fi “station”, which according to WEEE 802.11, Part 11, 3.316 is:
“ . . . A device that contains an IEEE 802.11-conformant media access control (MAC) and physical layer (PHY) interface to the wireless medium (WM) . . . ”

Fundamentally, therefore, the WPD of the invention is different to known Wi-Fi security implementations, which are executed beyond the PHY interface of an AP or Wi-Fi client. The WPD of the invention merely has a PHY interface to the WM, which enables it to broadcast and receive data to/from the WM, but does not connect to, or provide any connections for, APs or clients, respectively.

The method of securing the Wi-Fi network therefore permits connections to legitimate Wi-Fi access points, but denies connection to non-legitimate Wi-Fi access points. The method suitably safeguards client devices from connecting to non-legitimate Wi-Fi access points. The system prevents connection to a mimicking ESSID (network name) that is not in the whitelist of ESSIDs whether open or not.

The network scan is suitably performed using a Wi-Fi network scanner implemented in the WPD, which can be either a hardware or a software network scanner. The Wi-Fi network scanner suitably collects data pertaining to the detected, in-range Wi-Fi devices, such as, but without limitation to, network name (SSID), MAC address (BSSID), beacon interval, mode (e.g. 802.11a/b/g/n/ac), band (e.g. 2.4 GHz, 5 GHz, etc.), channel width, secondary channel offset, security mode, etc. A storage or memory device, such as an on-board memory or cloud-based repository, is suitably used to tabulate and store the data.

In certain embodiments of the invention, especially those that employ cloud-based storage of detected metrics, an administrator portal is suitably provided, which enables the detected metrics to be displayed and/or analysed. System administrators can suitably connect to the or each WPD using a web-based interface, such as a Wi-Fi connection or LAN connection associated with each WPD. However, it is to be noted that where a remote access interface is provided, this is entirely separate from the WPD of the invention. For example, the WPD may be housed inside a physical housing, which contains the hardware for the WPD as well as a separate client device. A security system is preferably provided between the WPD and the separate client device to enable the client device to poll the WPD for data and/or to upload data onto the WPD. The security system is suitably a high-security implementation, which uniquely locks the hardware of the respective WPD and client devices to one another, such that no other access point may gain access to data, share, download or upload data to/from the WPD other than the unique hardware access point to which the WPD is paired. The security measure implemented between the WPD and the client device is preferably implemented off the device itself, thus ensuring that only legitimate, securely logged-in administrators, accessing the AP via a secure administrator portal, and using correct encryption keys and security protocols are able to gain access to data, share, download or upload data to/from the WPD. These measures enable the WPD to be controlled remotely, for example, via a web portal, but do not permit making any physical connections local to the WPD hardware to gain access to data, share, download or upload data to/from the WPD.

Moreover, because the WPD is only a STA device, and not an AP or client, it will usually be invisible to other in-range Wi-Fi enabled device in-range of it.

The data collected from the network scan can be parsed to identify which detected devices are access points, and those which are clients. In one embodiment of the invention, any detected Wi-Fi devices having an SSID (network name) can be considered to be access points, whereas those not having an SSID and/or only having a BSSID (MAC address) can be considered to be clients. However, other determination techniques could be used (such as collecting both MAC address from the access point and the client).

The collected metrics from the network scan can be parsed to determine which client device is connected to which access point. This can be accomplished, for example, by grouping devices that are on the same channel, and/or by grouping devices whose clocks are synchronised to the same beacon frame. Other methods may equally be employed for this purpose.

The method of the invention also involves determining which access points are legitimate. Therefore, in certain embodiments, by a process of elimination, the method of the invention may also determine which access points are non-legitimate. The process of determining which access points are legitimate, and which are not, can be accomplished in a variety of ways.

It is to be noted that the invention is principally concerned with access points, and in particular, open APs, as these are the devices on the Wi-Fi network which can be used for “evil twin” attacks, but the invention is not restricted to acting against access points only.

In a first exemplary embodiment of the invention, a provider of a legitimate Wi-Fi service informs the WPD administrator or security provider of the SSIDs, MAC addresses and/or other data of the legitimate access points that it provides in a given location.

From this, the method of the invention can employ a “whitelist” system whereby all of the pre-notified access points are deemed legitimate, and all other access points are deemed non-legitimate. Such a configuration provides a robust security measure, as it only permits devices (clients) to connect to the pre-authorised access points. However, this approach does not differentiate between malicious, non-legitimate access points, and non-malicious access points which do not appear on the “whitelist”. It also does not necessarily differentiate between a legitimate AP and an “evil twin” AP that have identical SSIDs and/or passwords. However, by using additional information, such as combinations of the ESSID (network name), BSSID (MAC address); beacon interval; mode; band; channel; channel width; secondary channel offset; and security mode, etc. it is possible in almost all cases to differentiate between legitimate and “evil twin” APs even if they have the same ESSID and Wi-Fi password.

Additionally or alternatively, subscribers may provide a “blacklist” of ESSIDs, such as generic terms like “POOL-WIFI”, “CAFE”, “RESTAURANT”, “FREE-WIFI”, “GUEST-WIFI” etc., which the invention will always deem non-legitimate.

Such a conflict may arise, for example, where a user sets up a temporary Wi-Fi “hotspot” so that they can connect their laptop computer the internet via their mobile telephone. In this case, as the mobile telephone would not appear on the predetermined “whitelist”, the invention would prevent the laptop computer from connecting to it, which could be considered to be somewhat draconian—especially where the user has a perfectly legitimate reason for not using the open Wi-Fi system (e.g. if they are not a guest at the hotel; or if they intend to carry out internet banking or other secure transactions). However, in most cases where a mobile telephone is used as an ad-hoc hotspot AP, the hotspot is a secured hot spot requiring some form of pairing with the client device(s) and so this situation can be ignored by the WPD, which is principally concerned with open APs or secured APs with given ESSID and password combinations.

As such, the invention proposes using a multi-tiered approach to assess the legitimacy or otherwise of detected access points. Utilising/determining the validity/honesty of the access point by a series of rules based on the AP name and its closeness to the whitelist APs. This is based on the assumption that fraudulent AP activity is based on mimicking a known safe AP.

In another exemplary embodiment of the invention, the step of determining which access points are legitimate (or not) involves parsing the data collected from the network scan and identifying the security protocol in-use by each access point. In short, the method of the invention may deem any secured access points to be non-threatening, and may thus focus on, or pay greater attention to, detected “open” access points. The rationale behind this is that a password or otherwise secured access point would not be automatically connected to by a client device: it would require the user of the client device to select the access point and enter (or retrieve and use previously stored) login credentials. This presupposes, therefore, that a user of a secured access point does so with knowledge and consent (either at the time, or previously), and so the user is aware of his/her actions and consents to the connection. In such a situation, a legitimate provider of a nearby open Wi-Fi service cannot be held responsible if the user of the unrelated party's secured network suffers a cyber-attack during that connection.

Additionally or alternatively, there are cases where the ESSID of the “evil twin” device is clearly not legitimate. Such a situation might occur where, for example, an “evil twin” hotspot is set-up using an ESSID that has nothing to do with a legitimate nearby enterprise, for example “HOTELBRAND” or where it is installed in the vicinity of an entirely different hotel brand. In these situations, it would be the user of the client device who takes responsibility, but in any event, many of these types of “evil twin” access points could be guarded against using suitable blacklists, as mentioned above.

However, the invention can also be configured to safeguard against more sophisticated “evil twin” situations where, for example, a hacker obtains the ESSID and password of a legitimate access point (this can often be done quite easily—simply by requesting the login credentials from the service provider); and then proceeds to configure a malicious access point having the same ESSID and password as a legitimate access point. In this case, the end user, when identifying the network by its network name, and by gaining access to it by using the correct password, might nevertheless connect to a non-legitimate access point. The can invention safeguard against this type of attack by using additional metrics, such as the legitimate access points' MAC addresses and/or other metrics, to identify and protect against connections to more sophisticated “evil twin” access points.

In another exemplary embodiment of the invention, the step of determining which access points are legitimate (or not) involves parsing the data collected from the network scan and analysing the SSID in-use by each access point. According to this approach, the object is to identify access points that are attempting to “mimic” or replicate the SSID of a legitimate access point.

Suitably, the step of determining which access points are legitimate may involve comparing the string of characters used in the SSID of each access point with predetermined parameters.

In one example, this technique can be used to identify similar SSIDs that append prefixes of suffixes to the SSID of legitimate access points, such as by adding words like “free”, “superfast”, “pool”, “lobby”, “conference” etc. to the beginning or end of the SSID of a legitimate AP.

Additionally or alternatively, the technique can be used to identify similar SSIDs that append or insert punctuation marks, spaces or digits to or into the SSID of legitimate access points, such as by adding characters such as “-”, “_”, “ ”, “1”, etc. to or into the SSID of a legitimate AP.

Additionally or alternatively, the technique can be used to identify similar SSIDs that remove characters, spaces or punctuation marks from the SSID of legitimate access points.

Additionally or alternatively, the technique can be used to identify similar SSIDs that are misspellings of the SSID of legitimate access points.

Additionally or alternatively, the technique can be used to identify similar SSIDs that are equivalents to the SSID of legitimate access points, for example, by substituting the word “hotel” in a legitimate SSID with the string “guest house” or “BandB”; or “pool” for “spa”, etc.

In a preferred embodiment of the invention, the step of determining which access points are legitimate may involve using so-called fuzzy logic to compare the SSID of access points with the SSIDs of predetermined list of legitimate or pre-authorised access points.

In a preferred embodiment of the invention, the step of determining which access points are legitimate involves using a multi-tiered approach, such as, for example: open/Secure>whitelist/non-whitelist>different/similar; or whitelist/non-whitelist>open/Secure>different/similar; or different/similar>open/Secure>whitelist/non-whitelist. Any number or combination of approaches can be used.

In a preferred embodiment of the invention, the probability of a particular AP being a malicious one is calculated. This could be accomplished by using a similarity percentage, i.e. how similar a target SSID is to, for example, a whitelisted SSID. This approach may usefully enable a threshold to be set, above or below which, action is either taken or not.

For example, a particular Wi-Fi service provider may choose to set a relatively low threshold, say 30%, which would mean SSIDs that are even remotely similar to legitimate AP's SSIDs could be blocked. This would result in a tighter security regime with regard to operating hotspots or APs within its premises. On the other hand, a more relaxed Wi-Fi service provider may set a relatively high threshold value, say 85%, which would mean that a higher degree of similarity between the SSID of a given AP with that of a legitimate or whitelisted AP would be needed, and so fewer APs would be likely to be deemed non-legitimate. This would result in a more relaxed security regime with regard to operating hotspots or APs within its premises. A similar result could, of course, be accomplished by expanding or reducing the list of SSIDs in the whitelist.

There is a special case, of course, where the hacker manages to clone a legitimate access point. Cloning typically involves configuring the malicious access point so that it broadcasts an SSID, MAC address and/or other metrics which are identical with those of a legitimate AP. In this case, the malicious AP, and/or any connected client devices, might not be adequately protected as the step of determining which access points are legitimate might fail in such circumstances due to the malicious AP appearing to have the correct metrics. In this case, when the invention detects, using the both network scan, a duplicate device, it can be configured, in an abundance of caution, to deem both apparently identical devices as non-legitimate, and thus disconnect or prevent the connection between any clients and either detected AP. When such a situation arises, the invention is suitably configured to send a message to the provider of the legitimate Wi-Fi service, so that further investigation can be carried out, such as a “sweep” of the area for unauthorised devices, and/or replacement of the cloned device. In most cases, especially where there is built-in redundancy in the Wi-Fi provider's systems, the loss of one or more APs in a given area may not adversely affect the experience of end users.

In a most preferred embodiment of the invention, a “Rules Engine” (RE) is used to determine which detected in-range APs are legitimate, and which are not. The RE suitably adopts a multi-tiered approach to assessing the legitimacy or otherwise of detected in-range APs, for example, using different combinations and/or sequences of the techniques above, or other techniques known to those skilled in the art. Preferably, the RE is dynamic insofar as it may adopt different determination methodologies at different times. The RE is also preferably updatable, for example, by containing one or more RE algorithm(s) that are pushed to the WPD on-demand, at intervals or randomly, from a WPD administrator or platform. This is suitably accomplished by pushing RE updates from an administrator portal, such as by using a Wi-Fi or LAN connection to the WPD, which is secured in the manner described above.

The invention safeguards the end-users by disconnecting or preventing the connection between any clients that are connected to access points which have not been determined to be legitimate and the respective access point which has not been determined to be legitimate. This can be accomplished in a number of ways.

In a first embodiment of the invention, the invention is configured to instigate a Denial of Service (Dos) attack towards the non-legitimate AP. A sustained DoS attack usually results in the attacked AP resetting, which in-turn causes all clients connected to it to disconnect therefrom. The reset/reboot of the non-legitimate AP creates a “window of opportunity”, i.e. during the reboot cycle of the non-legitimate AP, in which the previously-connected clients will “see” an alternative AP with which to connect, which is hopefully a legitimate AP. In this case, when the non-legitimate AP goes live once more, the clients will have already established stable connections to a legitimate AP, thereby swapping the clients from the non-legitimate AP to a legitimate AP.

Additionally or alternatively, the step of disconnecting or preventing the connection between any clients that are connected to access points which have not been determined to be legitimate and the respective access point which has not been determined to be legitimate is accomplished using a deauthorisation procedure. To accomplish this, a number of steps may be involved. Until a client device connects to an AP, it is effectively invisible on the Wi-Fi network, and it is therefore not possible to safeguard it from connecting to non-legitimate APs. However, if a client device attempts to connect to a non-legitimate AP, it undergoes a “handshake” procedure, whereby the MAC address of the client becomes visible on the network. The network scan is suitably performed continuously, and so a new client attempting to connect to a non-legitimate AP is immediately identified. Given that the non-legitimate AP has already been identified, the invention can send a deauthorisation packet or packets to the client device, which deauthorises that client's connection to the non-legitimate AP. Therefore, before an effective connection by the affected client device beyond the non-legitimate AP's initial interface has been established, the deauthorisation packet or packets have been sent to the affected client, which causes the affected client device to disconnect and seek an alternative (hopefully legitimate) AP with which to connect.

The deauthorisation of the affected client device to the non-legitimate AP will remain in place until such time as it times-out or expires. Now that the MAC address of the affected client device is known to the invention, the invention can be configured to actively seek and guard that client device against connections to the non-legitimate AP, for example, by automatically deauthorising whenever it sees an attempt to connect to a non-legitimate AP; or by if the client device subsequently attempts to re-connect to the non-authorised AP, then the same procedure will be repeated, and the connection will be prevented. Accordingly, the client will be swapped, unobtrusively, from a non-legitimate AP to a legitimate AP.

The deauthorisation procedure differs from other known disconnect procedures insofar as the non-legitimate AP is not affected in any way because the deauthorisation is directed to the client, rather than to the AP. This has the advantage of not actively “interfering” with, or “attacking” any AP in the network, but rather simply safeguarding the client devices from potentially malicious APs.

Embodiments of the invention shall now be described, by way of example only, with reference to the accompanying drawings in which:

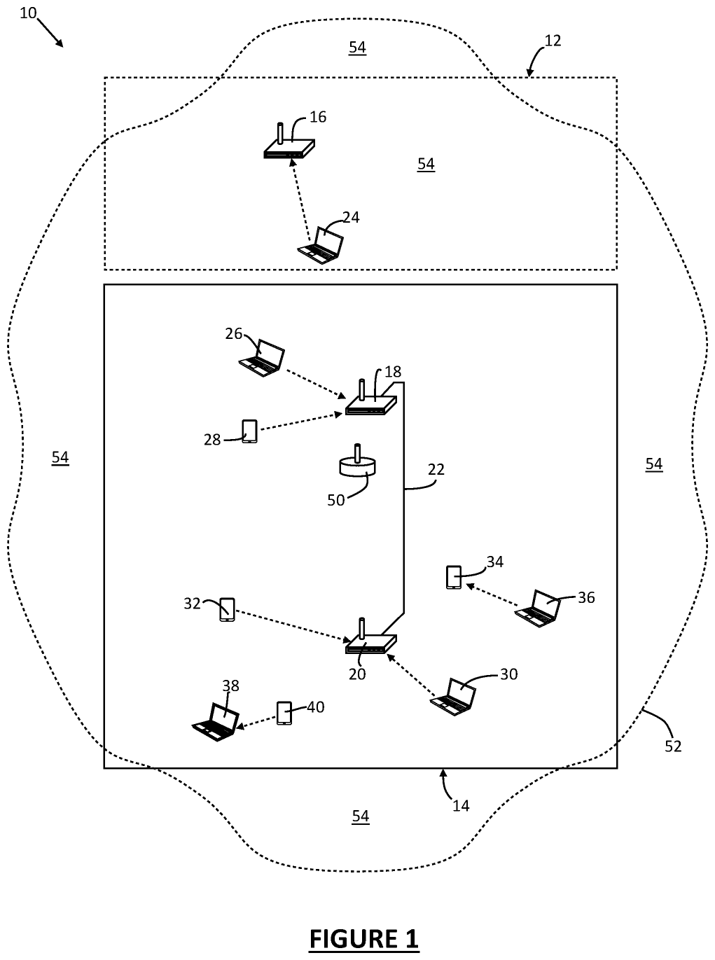

FIG. 1 is a schematic representation of a typical Wi-Fi environment;

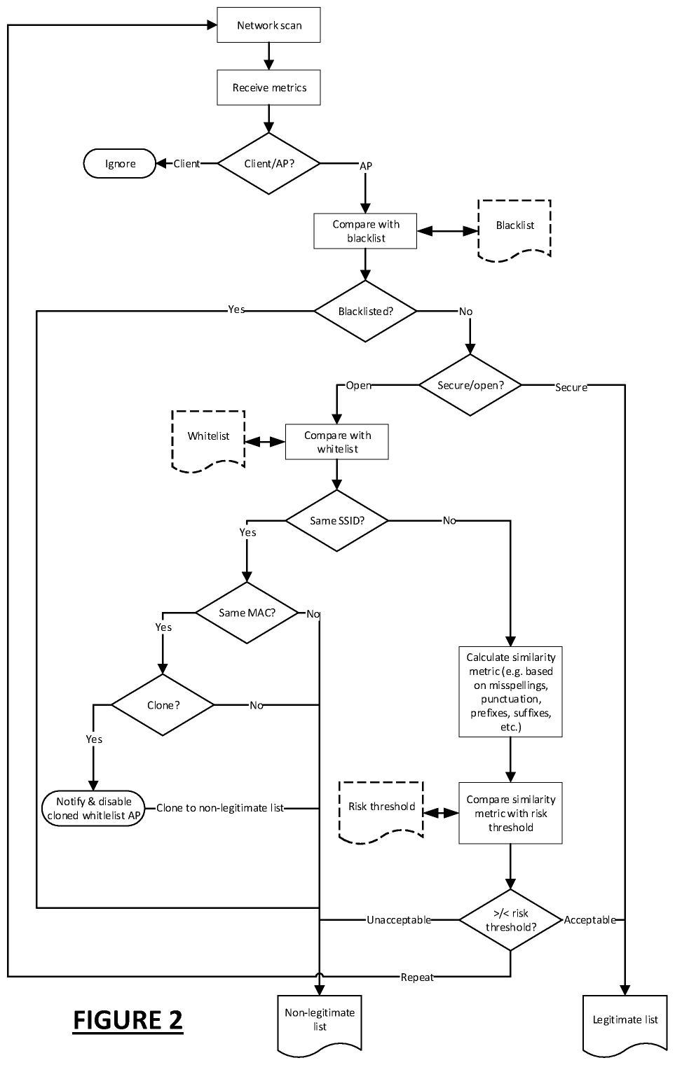

FIG. 2 is a flowchart illustrating the operation of an embodiment of the invention; and

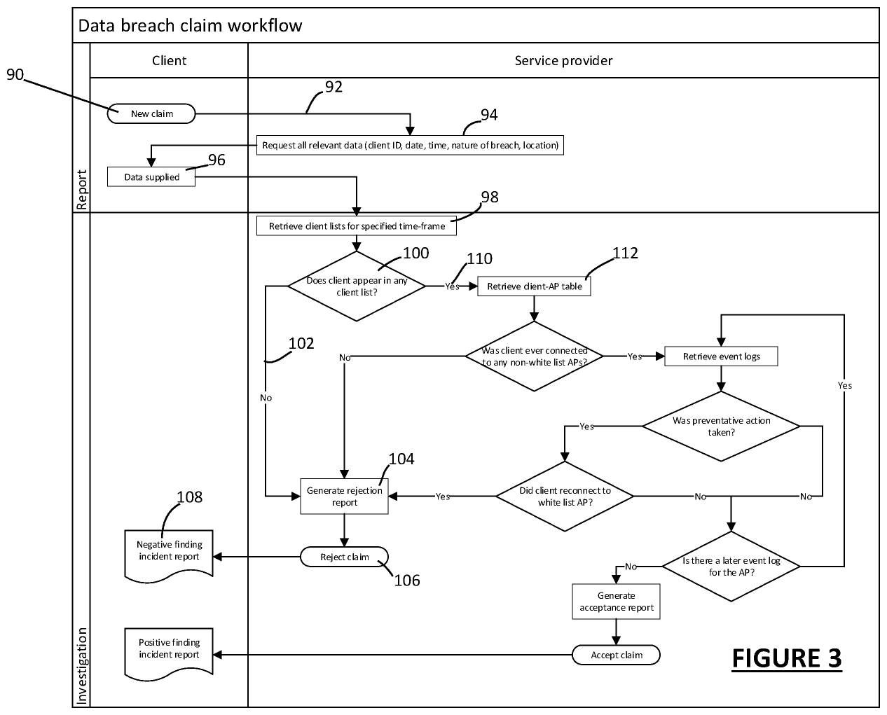

FIG. 3 is a schematic flowchart illustrating a data breach analysis.

Referring to FIG. 1 of the drawings, a typical Wi-Fi environment 10 is shown, in which there are neighbouring premises 12, 14, each providing separate Wi-Fi services via respective open Wi-Fi access points 16, 18, 20. Users can enter either premises (in the illustrated example, a coffee shop 12, which is located adjacent a hotel lobby 14) and connect to Wi-Fi services on an ad-hoc basis.

Each user has a Wi-Fi enabled device, such as a laptop computer or a mobile telephone, and upon entering the premises 12, 14, their devices seek out available Wi-Fi access points. Upon detection of one or more open access points, the devices typically connect automatically to the AP with the strongest Wi-Fi signal. If no open APs are available, then the device may prompt the user to enter login credentials, which are often suppled by the proprietor of the premises 12, 14 to users, upon request.

In the illustrated example, the coffee shop 12 operates open AP 16, which has an SSID of “COFFEE-WIFI”. Likewise, the hotel 14 operates a pair of ethernet 22 connected open APs 18, 20, which both have the same SSID, namely “HOTEL-WIFI”. The connections between the client devices and the respective access points are indicated, schematically, by the dashed arrows in FIG. 1, i.e. laptop 24 is connected to AP 16; laptop 26 and phone 28 are connected to AP 18; and laptop 30 and phone 32 are connected to AP 20.

In addition to this, a user, for example, wishing to use a private, secure internet connection rather than the open Wi-Fi network, has configuring their phone 34 as a “hotspot”, so that they can connect their laptop 36 to the internet, via the phone 34, using a 4G mobile telephony data service. The SSID of the phone 34 is, in this example, “BOBSWORKPHONE” and requires a password for the laptop 36 to connect to it.

In addition, a malicious user has configured their laptop computer 38 as a “hotspot”, and has configured the hotspot so that its SSID is “SUPERFAST-HOTEL-LOBBY”. The hotspot is open, requiring no login credentials, and so another user's phone 40 has automatically connected to it 38, rather than to the legitimate, nearby open Wi-Fi AP 20.

In addition to the above, there is provided a Wi-Fi protection device (WPD) 50 in accordance with the invention, which comprises a transceiver located within the hotel's premises 14. The WPD 50 is a station device, but is also neither a client device nor an access point. The WPD 50 is not connected to any Wi-Fi network (but may be connected to an Ethernet network securely as described above), but has a wireless range indicated by dashed line 52, which encompasses the premises 14 to be protected, as well as portions 54 of neighbouring premises.

The WPD 50 is pre-configured according to the requirements of the subscriber, in this case, the hotel proprietor, who as previously submitted a “whitelist” containing a list of the legitimate APs. In this basic example, the whitelist AP SSIDs are simply “HOTEL-WIFI”. In addition, the subscriber specifies a security level (strict/relaxed), which the WPD 50 takes into account during operation.

In FIG. 2, a first stage of the operation of the WPD 50 is shown, in which the procedure begins by the WPD 50 carrying out a network scan to collect data/metrics of all Wi-Fi enabled devices in range 52. The WPD 50 receives data back from all in-range Wi-Fi enabled devices, and populates a device list, such as:

| ID | ESSID | BSSID | Channel | Encryption |
|---|---|---|---|---|
| 16 | COFFEE-WIFI | 19:af:ff:34:51:5e | 6 | Open |
| 24 | | 26:32:ae:16:d3:fa | 6 | |
| 18 | HOTEL-WIFI | 40:96:9e:22:b3:a1 | 18 | Open |
| 26 | | 43:21:d3:d1:9b:53 | 18 | |
| 28 | | 34:c6:12:ee:1f;75 | 18 | |
| 20 | HOTEL-WIFI | 30:bd:12:ae:14:2a | 11 | Open |
| 32 | | 45:5d:38:aa:ab:ff | 11 | |
| 30 | | 12:34:14:ef:fa:16 | 11 | |
| 34 | BOBSWORKPHONE | 43:32:a4:f6:aa:e3 | 6 | WPA2 |
| 36 | | 26:11:aa:fe:23:1f | 6 | |
| 38 | SUPERFAST- | 12:34:2e:1f:22:ee | 7 | Open |
| | HOTEL-LOBBY | | | |
| 40 | | 16:32:ab:17:f4:e1 | 7 | |

From this table, the WPD 50 is able to determine that devices 16, 18, 20, 34 and 38 are all APs; and that devices 24, 26, 28, 32, 30, 36 and 40 are all clients. Clients can be disregarded in this particular exemplary embodiment of the invention, and the WPD's 50 attention is then focused on the APs 16, 18, 20, 34, 38.

The first step in the procedure is to identify which APs are “open” and which are “secured”. In this particular exemplary embodiment of the invention, device 34 (BOBSWORKPHONE) is secured using WPA2 (or any other suitable protocol) and is thus determined to pose a low/nil security risk for the reasons previously stated, and can be considered “legitimate”. The associated, connected client device 36, can also be disregarded, or considered “legitimate”. However, open APs 16, 18, 20 and 38 require more detailed consideration.

The WPD 50 therefore refers to the previously-provided whitelist and compares all of the detected open AP's credentials with those on the whitelist. From this comparison, it is clear that APs 18 and 20 are “legitimate” because their ESSIDs (network names) and BSSIDs (MAC addresses) correspond to those in the whitelist and can thus be disregarded and added to the list of “legitimate” APs. Attention is then directed to the remaining open APs, namely APs 16 and 38.

The next step in the procedure, as can be seen from FIG. 2 of the drawings, is to compare the SSID of APs 16 and 18 and to calculate a “similarity metric”.

In this particular exemplary embodiment, AP 16 with SSID “COFFEE-WIFI” is deemed to be dissimilar, according to the subscriber's specified security level, due to the high degree of dissimilarity between “COFFEE” and “HOTEL”. AP 16 can thus be added to the list of “legitimate” APs.

However, AP 38 with SSID “SUPERFAST-HOTEL-LOBBY” is deemed to be similar, according to the subscriber's specified security level, due to the high degree of similarity between the respective SSIDs. AP 38 is thus added to a list of “non-legitimate” APs.

In one embodiment of the invention, the WPD 50 then initiates a DoS attack against the non-legitimate AP, causing the connected client device 40 to disconnect and seek an alternative, legitimate AP, such as AP 20 in this example. However, DoS attacks are somewhat “brute-force” and can disrupt other essential services.

A preferred method of providing Wi-Fi protection is, having identified one or more non-legitimate APs, for the WPD 50 to identify (e.g. from the table above) any clients connected to non-legitimate APs, which in this particular exemplary embodiment, would be client device 40. The WPD 50, now knowing the MAC address of the affected client(s) then sends a deauthorisation packet or packets to the affected client device 40 or devices, which causes it/them to disconnect from the respective non-legitimate AP. Now that the non-legitimate APs have been deauthorised on the respective client device(s) 40, subsequent connection by the affected client device(s) 40 to the non-legitimate AP(s) is prevented. Accordingly, the affected client devices 40 seek to connect with another available AP, which would (hopefully) be a legitimate AP.

As the whole procedure is carried out repeatedly and continuously, detection of new, non-legitimate APs occurs immediately upon any client device attempting to connect to it. Thus, protective action (deauthorising the client device from the non-legitimate AP) can also be taken before any potentially affected client device is able to properly/fully connect to any non-legitimate AP. This safeguards the client devices under the protection of the WPD 50 from inadvertently connecting to “evil twin” APs.

In a more sophisticated attack, the hacker controlling AP 38 names the SSID identically with the SSID of a legitimate AP, in this case, both the malicious AP 38 and the legitimate APs 18, 20 all have an SSID of “HOTEL-WIFI”, which SSID appears in the subscriber's whitelist. The network scan table may thus be as follows:

| ID | ESSID | BSSID | Channel | Encryption |
|---|---|---|---|---|
| 16 | COFFEE-WIFI | 19:af:ff:34:51:5e | 6 | Open |
| 24 | | 26:32:ae:16:d3:fa | 6 | |
| 18 | HOTEL-WIFI | 40:96:9e:22:b3:a1 | 18 | Open |
| 26 | | 43:21:d3:d1:9b:53 | 18 | |
| 28 | | 34:c6:12:ee:1f;75 | 18 | |
| 20 | HOTEL-WIFI | 30:bd:12:ae:14:2a | 11 | Open |
| 32 | | 45:5d:38:aa:ab:ff | 11 | |
| 30 | | 12:34:14:ef:fa:16 | 11 | |
| 34 | BOBSWORKPHONE | 43:32:a4:f6:aa:e3 | 6 | WEP |
| 36 | | 26:11:aa:fe:23:1f | 6 | |
| 38 | HOTEL-WIFI | 12:34:2e:1f:22:ee | 7 | Open |
| 40 | | 16:32:ab:17:f4:e1 | 7 | |

In this case, the previously-described approach might fail due to the identity between the respective SSIDs, so the WPD 50, as shown in FIG. 2, upon detection of multiple APs 18, 20, 38 with the same SSID also cross-checks the MAC addresses of the respective devices with those appearing in the whitelist. As the MAC address of any AP is factory-set, even though the SSIDs might be the same, the WPD 50 would be able to distinguish between legitimate APs having a given SSID, and non-legitimate ones. The non-legitimate APs would this be added to the non-legitimate list, and the protection of the connected/affected client devices would occur as described hereinabove.

In certain cases, the hacker might also manage to clone a legitimate AP, that is to say, obtain the MAC address of a legitimate AP and configure the malicious AP so that its MAC address appears to be the same as an AP on the whitelist. The network scan table may thus be as follows:

| ID | ESSID | BSSID | Channel | Encryption |
|---|---|---|---|---|
| 16 | COFFEE-WIFI | 19:af:ff:34:51:5e | 6 | Open |
| 24 | | 26:32:ae:16:d3:fa | 6 | |
| 18 | HOTEL-WIFI | 40:96:9e:22:b3:a1 | 18 | Open |
| 26 | | 43:21:d3:d1:9b:53 | 18 | |
| 28 | | 34:c6:12:ee:1f;75 | 18 | |
| 20 | HOTEL-WIFI | 30:bd:12:ae:14:2a | 11 | Open |
| 32 | | 45:5d:38:aa:ab:ff | 11 | |
| 30 | | 12:34:14:ef:fa:16 | 11 | |
| 34 | BOBSWORKPHONE | 43:32:a4:f6:aa:e3 | 6 | WEP |
| 36 | | 26:11:aa:fe:23:1f | 6 | |
| 38 | HOTEL-WIFI | 30:bd:12:ae:14:2a | 7 | Open |
| 40 | | 16:32:ab:17:f4:e1 | 7 | |

As can be seen from FIG. 2 of the drawings, the WPD 50 safeguards against this eventuality also by, upon detection of a suspected “clone” device, deauthorise both the cloned AP 20 and the clone AP 38 by sending deauthorisation packets to all affected client devices 30, 32, 38. Additionally or alternatively, the WPD 50 may inform the subscriber of the potential clone device so that appropriate action (such as a “sweep”) can be carried out. Additionally or alternatively, the WPD 50 may disable the cloned device as an additional safeguarding measure.

It is to be appreciated that the WPD 50 may be used in a multi-tenanted environment, such as in a shopping mall, as shown in FIG. 1; or in a shared office building (not shown). Multi-subscriber configurations are relatively easy to implement because each subscriber can submit their own whitelist(s) and set their own security levels. Because the WPD 50 is not actually connected to any particular network, it is able to implement different rules and procedures for each subscriber. In the example of FIG. 1, the coffee shop 12 proprietor may submit a whitelist containing its AP's credentials, and the WPD 50 can be configured to implement security procedures in respect of that subscriber independently, or in conjunction with, other subscribers, such as the proprietor of the adjacent hotel 14.

A web-based user interface (not shown) is suitably provided to enable administrators of the WPD 50, or subscribers to the WPD 50, to review, edit, analyse etc. data therein.

An important aspect of the invention is its ability to log data, connections, events etc., to provide an audit trail in the event of alleged “evil twin” (or indeed other types of) cyber-attack. As such, the WPD 50 is suitably configured to generate and store event logs for historical/audit purposes. This enables administrators or subscribers to document and record security measures that it has implemented within networks.

As such, any alleged data breach can be properly investigated and an accurate and verifiable report generated to determine whether or not a cyber-attack occurred whilst the customer (or more particularly, their client device) was in the premises 12, 14 of a network protected by the invention.

In a first example, a customer using a PC alleges that a data breach took place at a given time and location.

Referring now to FIG. 3 of the drawings, this is deemed a new claim 90, which is submitted 92 to the service provider. The service provider, upon receipt of the new claim 90, requests 94 data regarding the allegation, which the customer supplies 96, including the client device's MAC address. Having received the data back 96 from the customer, the service provider is able to retrieve 98 all of the client lists, AP lists, white lists and event logs for the specified timeframe and checks 100 whether or not the MAC address of the client device appears in any of the client lists at all.

If the client does not appear in any of the client lists 102, because it was not detected on any network during the specified timeframe, the claim can be rejected, and a report generated.

In this particular case, however, a device with the given MAC address was detected, but it was detected as connecting to access point 16, that is to say the access point in an adjacent premises 12. An incident report such as that illustrated below, could thereby be generated 104, the claim rejected 106, and a negative report 108 sent back to the customer.

As there is a reciprocal relationship between the provider of access point 16 and the protected network 18, 20, the instant report suggests that the customer contacts the other provider 12 for further information.

In the next example, a customer complains 90 of a data breach occurring at a particular point in time. In this case, the client lists for the specified timeframes are retrieved 98, and the client's MAC address does 110 appear in the client list.

The client access point table 112 is therefore retrieved, from which it is determined that the device in question, in fact, connected to malicious access point 38. The incident report specifies that the connection of the client to access point 38 was detected at a particular point in time; that a deauthorisation packet was sent to the client with MAC address 16:32:ab:17:f4:e1 at time T1; that at time T2, the network was rescanned and it was determined that the client with MAC address 16:32:ab:17:f4:e1 had disconnected from all networks; and that the client with MAC address 16:32:ab:17:f4:e1 reconnected to legitimate access point 20 at time T3. The incident report also confirms that the Wi-Fi network was re-scanned and that no further connections between the client with MAC address 16:32:ab:17:f4:e1 and malicious access point 20 were made.

A further example of an incident report is shown below in which a complainant alleges to have suffered a data breach whilst connected to a network under the control of the proprietor. In this case, the Wi-Fi scan logs indicate that at no point did any device with the given MAC address connect to any known networks under the control of the proprietor.

A further advantage of the invention, due to its installation alongside Wi-Fi networks, is that it can also incorporate a separate Wi-Fi client device that can, as and when required, be configured to carry out network analysis, such as: on-boarding tests to ensure the Wi-Fi Access Point is responding in a timely manner; download/upload tests to see raw numbers for uploading/downloading data; loading a selection of webpages and logging the time to render completely; streaming a video to evaluate the quality of playback that is possible; latency tests to determine how well a user would be able to game on the connection; latency/download tests to determine the quality of a VOIP call on the connection, etc.

Any one or more of the aforementioned tests could be carried out manually against a specific AP, scheduled against specific APs, manually against a random AP, scheduled against a random AP within the subscriber's network, randomly against a specific network, or randomly against a random network.

The tests carried out can also be tailored to a subscriber's specific needs, so if, for example, a particular subscriber requires downloading/uploading to a specific country/server then the tests can be set-up to reflect this. Reports are generated using a set of pre-determined metrics which give some context regarding what the actual results mean. Such a system enables subscribers to provide metrics to their customers regarding their networks' performance (for example, hotels could advertise their HD/4K streaming performance in bedrooms, or their upload/download speeds by the pool, etc.).

As previously mentioned, the WPD is suitably contained within a physical housing and comprises a Wi-Fi transceiver providing a PHY connection to the WM. The transceiver suitably comprises a MIMO-type transceiver, having various transceivers and/or antennas for redundancy, but also such that functions like network scanning, the broadcasting of deauthorisation packets and the like can executed using dedicated transceivers/antennas in parallel. Preferably, four transceivers are provided, which provides for adequate parallel operation, as well as providing redundancy and the option to add further features at a later date.

A circuit board is provided within the housing, which has the hardware associated with the transceiver embedded within it, as well as a memory module and a processor to enable the WPD 50 to function as a stand-alone device. To further facilitate this, a rechargeable battery or supercapacitor is also provided for powering the WPD 50, which can be a stand-alone power source, or which may form part of an uninterruptible power supply (UPS system).

A security module is ideally provided within the WPD, which prevents and/or inhibits unauthorised access to the physical circuit board and/or any data on it and/or any I/O part of it.

A separate AP or network interface may also be provided, to enable the WPD to communicate securely with other networks/systems, such as to a remote administration portal. The security module sits between the AP or network interface and the WPD and uniquely locks the hardware of the respective WPD and AP or network interface to one another. Accordingly, no AP other than the physically and/or logically paired AP or network interface can gain access to data, share, download or upload data to/from the WPD other than the unique hardware AP or network interface to which the WPD is paired.

An encryption key is suitably used to ensure that only legitimate, securely logged-in administrators, accessing the AP or network interface, via a secure administrator portal, and using correct encryption keys and security protocols are able to gain access to data, share, download or upload data to/from the WPD.

Anti-tamper and/or tamper-evident devices may be provided in or associated with, the WPD. These could include microswitches to detect opening of the housing or removal of the housing from a wall/ceiling mount; orientation sensors to detect changes in attitude of the housing; voltage sensors to detect connection and/or disconnection of power cables, network cables, etc. from the WPD; and/or luminance sensors to detect opening of an outer casing of the WPD and/or removal of the WPD from a mounting surface. Each sensor, where provided, suitably reports it status, or at least significant changes in status, to a remote administrator, where possible, or to the WPD itself, either or both of which can adopt a multi-tiered approach to “self-protection” of the WPD including measures such as powering down and/or data encryption and/or data destruction.

The invention is not necessarily restricted to specific details of any of the foregoing exemplary embodiments.

1. A method of securing a Wi-Fi network comprising the steps of:
using a Wi-Fi Protection Device (WPD):
performing a network scan to detect all in-range Wi-Fi devices;
identifying any access points from among the list of all detected in-range Wi-Fi devices;
identifying any client devices from among the list of all detected in-range Wi-Fi devices;
determining the access points to which each detected client device is connected;
determining which access points are legitimate; and
disconnecting or preventing the connection between any clients that are connected to access points which have not been determined to be legitimate and the respective access point which has not been determined to be legitimate.

2. The method of claim 1, wherein the step of determining which access points are legitimate comprises: providing a list containing the metrics of legitimate access points; and deeming all detected access points whose metrics correspond to those on the list as legitimate.

3. The method of claim 2, further comprising the step of deeming all detected access points whose metrics do not correspond to those on the list as non-legitimate.

4. The method of claim 2, wherein the metrics comprises any one or more of the group comprising the access point's: ESSID or network name; BSSID or MAC address; beacon interval; mode; band; channel; channel width; secondary channel offset; and security mode.

5. The method of claim 1, wherein the step of determining which access points are legitimate comprises:
parsing the data collected from the network scan and identifying a security protocol in-use by each detected access point;
deeming all secured access points as legitimate; and
deeming all open access points as non-legitimate, or potentially non-legitimate.

6. The method of claim 5, further comprising, for an access point deemed non-legitimate, or potentially non-legitimate, determining whether the access point is attempting to mimic or replicate a deemed legitimate access point by using the same, or a similar, ESSID or network name to an access point deemed legitimate.

7. The method of claim 6, wherein determining whether the access point is attempting to mimic or replicate a deemed legitimate access point comprises comparing strings of characters used in the ESSID of the access point under consideration with the ESSIDs of access points in the list of claim 2.

8. The method of claim 6, wherein determining whether the access point is attempting to mimic or replicate a deemed legitimate access point comprises comparing strings of characters used in the ESSID of the access point under consideration with predetermined character strings, the comparison being any one or more of the group consisting of:
a. identifying prefixes or suffixes appended to the ESSID of a legitimate access point;
b. identifying the presence of punctuation marks, spaces or digits to or into the ESSID of a legitimate access point;
c. identifying the removal of characters, spaces or punctuation marks from the ESSID of a legitimate access point;
d. identifying a misspelling of the ESSID of a legitimate access point;
e. identifying equivalents to a part, or parts, of the ESSID of a legitimate access point; and
f. using fuzzy logic to compare the ESSID of access point under consideration with the ESSID of a legitimate access point.

9. The method of any claim 8, further comprising the steps of:
determining a similarity metric, being an indication of a degree of similarity between the ESSID of an access point under consideration and the ESSID of one or more legitimate access points;
determining whether the similarity metric is above or below a specified threshold value; and
if the similarity metric is above the specified threshold value, deeming the access point under consideration non-legitimate; or
if the similarity metric is below the specified threshold value, deeming the access point under consideration legitimate.

10. The method of claim 1, wherein the step of disconnecting or preventing the connection between any clients that are connected to access points which have not been determined to be legitimate and the respective access point which has not been determined to be legitimate comprises sending a deauthorisation packet or packet to the said client device, which deauthorises the said client's connection to the non-legitimate AP.

11. The method of claim 1, comprising the step of sending a further deauthorisation packet or packet to the said client device, which deauthorises the said client's connection to the non-legitimate AP should the said client device subsequently attempt to connect to the said deemed non-legitimate access point.

12. The method of claim 1, wherein the network scan is performed using a hardware or software Wi-Fi network scanner.

13. The method of claim 13, wherein the Wi-Fi network scanner is not connected to any of the networks which it detects.

14. The method of claim 1, wherein:
the step of identifying the access points from among the list of all detected in-range Wi-Fi devices comprises deeming any detected Wi-Fi devices having an ESSID or network name to be access points; wherein
the step of identifying the client devices from among the list of all detected in-range Wi-Fi devices comprises deeming any detected Wi-Fi devices having only a BSSID or MAC address to be client devices; and wherein
the step of determining the access points to which each detected client device is connected comprises any one or more of:
grouping devices by common characteristics or metrics;
grouping devices that are on the same channel; and
grouping devices whose clocks are synchronised to the same beacon frame.

15. The method of claim 1, comprising the step of logging and optionally storing for later retrieval, data relating to devices on the network, connections between devices on the network, and protective measures implemented by the invention.

16. The method of claim 1, further comprising the step of providing a separate client device, and configuring the client device to perform network analysis, the network analysis being any one or more of the group comprising: on-boarding tests; download/upload tests; media streaming tests; latency tests; and connection tests to deemed non-legitimate access points.

17. A Wi-Fi Protection Device, which is neither a client device nor an access point device, comprising a Wi-Fi transceiver adapted to performing a network scan to detect all in-range Wi-Fi devices and to interact with in-range Wi-Fi devices to disconnect or prevent them from forming connections, and a processor adapted to carry out the method of claim 1.

18. The Wi-Fi Protection Device of claim 18, comprising any one or more of the group consisting of:
c. an uninterruptable power supply;
d. an additional physically and/or logically separate Wi-Fi transceiver or network interface for connection to a computer network; and
e. anti-tamper or tamper-evident protection means for securing the Wi-Fi Protection Device.
